(19) United States
(12) Patent Application Publication
(10) Pub. No.: US 2025/0130210 A1
(43) Pub. Date: Apr. 24, 2025

(54) AUTOMATIC DATA PROCESSING FOR MASS SPECTROMETRY

(71) Applicant: DH Technologies Development Pte. Ltd., Singapore (SG)

(72) Inventors: Chang LIU, Richmond Hill (CA); Cristiano VEIGA, Toronto (CA)

(73) Assignee: DH Technologies Development Pte. Ltd., Singapore (SG)

(21) Appl. No.: 18/688,450

(22) PCT Filed: Aug. 31, 2022
(86) PCT No.: PCT/IB2022/058190

§ 371 Date: Mar. 1, 2024

Related U.S. Application Data
(60) Provisional application No. 63/240,721, filed on Sep. 3, 2021.

(51) Int. Cl. G01N 30/72; G01N 30/02; G01N 30/86; G01N 30/88; H01J 49/04

(52) U.S. Cl. CPC G01N 30/7233; G01N 30/8631; G01N 30/88; H01J 49/045; G01N 2030/027; G01N 2030/8804

(57) ABSTRACT

Methods and systems for mass analysis are disclosed herein. An example system includes: a sample ejector configured to eject a plurality of samples from a plurality of wells of a well plate; a capture probe configured to capture the ejected samples and dilute and transport the captured samples; a nebulizer nozzle configured to receive and ionize the transported diluted samples to produce sample ions; a mass analysis instrument configured to filter and detect ions of interest from the sample ions; a controller configured to coordinate operations of the sample ejector, the capture probe, the nebulizer nozzle, and the mass analysis instrument; and a data processing system configured to acquire data from the mass analysis instrument and conduct an automatic data processing process.

### CROSS-REFERENCE TO RELATED APPLICATION

This application is being filed on Aug. 31, 2022, as a PCT International Patent Application that claims priority to and the benefit of U.S. Provisional Application No. 63/240,721, filed on Sep. 3, 2021, which application is hereby incorporated by reference in its entirety.

### INTRODUCTION

High throughput sample analysis is desirable in many fields such as pharmaceutical development, clinical screening, quality control, etc. High throughput sample analysis usually generates a large quantity of raw data in a relatively short time. For example, a high throughput mass spectrometry (MS) analysis for a sample pool or collection containing hundreds or thousands of samples, depending on methods of sample preparation and analysis, may generate a single MS dataset that includes an excessively large compilation of sub-datasets with respect to each individual sample. In many situations, the samples in a high throughput MS analysis are analyzed successively without interruption, and the resultant single large MS dataset is unsplit and unprocessed. Subsequent processing the single large dataset is not only time-consuming but sometimes can be a bottleneck for the overall productivity of sample analysis. In addition, data processing for high throughput MS analysis is also technically challenging. Due to the large quantity of data, any deficiency in data processing, however trivial, may result in a chain of mistakes, and may undermine the accuracy of analyte identification and/or the confidence of the analytical results for each individual sample, if not resolved timely.

### SUMMARY

In one aspect, the present disclosure provides a system for analyzing a collection of substance samples. In one particular example, the system includes: a sample ejector configured to eject, independently, a plurality of samples from a plurality of wells of a well plate, each of the plurality of samples corresponding to each of the plurality of wells; a capture probe configured to capture the ejected samples and dilute and transport the captured samples; a nebulizer nozzle configured to receive and ionize the transported diluted samples to produce sample ions; a mass analysis instrument configured to filter and detect ions of interest from the sample ions; a controller configured to coordinate operations of the sample ejector, the capture probe, the nebulizer nozzle, and the mass analysis instrument; and a data processing system connected with the mass analysis instrument and the controller, wherein the data processing system is configured to acquire data from the mass analysis instrument and conduct an automatic data processing process.

In some embodiments of the present system, the automatic data processing process is triggered by completion of the acquiring the data from the mass analysis instrument.

In some embodiments of the present system, the automatic data processing process includes correlating intensity peaks in an intensity-versus-time signal with the plurality of samples from the plurality of wells. In some embodiments, the automatic data processing process further includes splitting the data to generate a plurality of data subsets, each of the plurality of data subsets corresponding to each of the plurality of samples from the plurality of wells. In some embodiments, the intensity peaks in the intensity-versus-time signal is correlated with the plurality of samples from the plurality of wells, based on acoustic ejection timing information of the sample ejector. The automatic data processing process further includes introducing a compound file comprising information of one or more target compounds for each of the plurality of samples. In some embodiments, the automatic data processing process further includes generating one or more mass spectra corresponding to the one or more target compounds for each of the plurality of samples. In some embodiments, the automatic data processing process further includes: generating a background spectrum; and subtracting the background spectrum from the one or more mass spectra.

In some embodiments, the automatic data processing process further includes: identifying abnormal samples, among the plurality of samples, based on one or more validation rules. In some embodiments, the one or more validation rules includes a first validation rule, under which each of the abnormal samples has a mass shift larger than a threshold mass shift. In some embodiments, the one or more validation rules includes a second validation rule, under which each of the abnormal samples has an isotope pattern distribution similarity smaller than a threshold isotope pattern distribution similarity. In some embodiments, the automatic data processing process further includes: prompting, to a user of the system, a notification of the abnormal samples. In some embodiments, the automatic data processing process further includes: sending a feedback message comprising information of the abnormal samples to the controller. In some embodiments, the automatic data processing process further includes: adjusting the operations of the sample ejector, the capture probe, the nebulizer nozzle, and the mass analysis instrument, based on the feedback message. In some embodiments, the automatic data processing process further includes: ejecting, independently, the abnormal samples, based on the feedback message.

In some embodiments of the present system, the automatic data processing process further includes: visualizing the one or more mass spectra corresponding to the one or more target compounds for each of the plurality of samples. In some examples, the automatic data processing process is operative to generate a heat map that provides users an overview of all samples from the entire well plate, with respect to a particular characteristic of the sample. Such characteristic may include mass spectrum, total ion current (TIC) chromatogram, or extracted ion (XIC) chromatogram, etc. The generated heat map can be provided on a user interface such as a graphic user interface (GUI), where a user may view the heat map and select any plots of interest to retrieve more information related to the selected plots and the corresponding samples. For example, a user may select particular plots shown in the heat map and visualize the mass spectra of the related samples. Alternatively, a user may view the TIC and/or the XIC of the samples selected from the heat map without the full mass spectral information. In some examples, multiple heat maps can be generated by the automatic data processing process, each heat map depicting a distinct characteristic of the samples from the entire well plate. In some embodiment, the automatic data processing process further includes: generating a report file comprising information of the one or more mass spectra corresponding to the one or more target compounds for each of the plurality of samples.

In another aspect, the present disclosure relates to za method for analyzing collection of substance samples. In one particular example, the method includes: ejecting, by a sample ejector, a plurality of samples from a plurality of wells of a well plate, independently, each of the plurality of samples corresponding to each of the plurality of wells; capturing, by a capture probe, the ejected samples and diluting and transporting the captured samples; ionizing, by a nebulizer nozzle, the transported diluted samples to produce sample ions; filtering and detecting, by a mass analysis instrument, ions of interest from the sample ions; coordinating, by a controller, operations of the sample ejector, the capture probe, the nebulizer nozzle, and the mass analysis instrument; and acquiring, by a data processing system connected with the mass analysis instrument and the controller, data from the mass analysis instrument and conducting an automatic data processing process.

In yet another aspect, the present disclosure relates to a non-transitory computer-readable medium containing program instructions, wherein execution of the program instructions by one or more processors causes a system for analyzing collection of substance samples to: eject, by a sample ejector, a plurality of samples from a plurality of wells of a well plate, independently, each of the plurality of samples corresponding to each of the plurality of wells; capture, by a capture probe, the ejected samples and dilute and transport the captured samples; ionize, by a nebulizer nozzle, the transported diluted samples to produce sample ions; filter and detect, by a mass analysis instrument, ions of interest from the sample ions; coordinate, by a controller, operations of the sample ejector, the capture probe, and the mass analysis instrument; and acquire, by a data processing system connected with the mass analysis instrument and the controller, data from the mass analysis instrument and conduct an automatic data processing process.

The details of one or more techniques are set forth in the accompanying drawings and the description below. Other features, objects, and advantages of these techniques will be apparent from the description, drawings, and claims.

### BRIEF DESCRIPTION OF THE DRAWINGS

FIG. 1 is schematic diagram illustrating one exemplary mass analysis system 10 in accordance with various aspects and embodiments of the present disclosure.

FIG. 2 is schematic diagram illustrating another exemplary mass analysis system 10′ in accordance with various aspects and embodiments of the present disclosure.

FIG. 3 is a schematic diagram illustrating one example of the centralized control system 20 in accordance with various aspects and embodiments of the present disclosure.

FIG. 4 is a schematic diagram illustrating one particular example of the computing device 200 in accordance with various aspects and embodiments of the present disclosure.

FIG. 5 depicts a schematic view of an example system combining an acoustic droplet ejection system with a sampling interface and an ion source.

FIG. 6 is a block diagram illustrating one example of the data processing system 400 of FIGS. 1-2, in accordance with various aspects and embodiments of the present disclosure.

FIG. 7 is a block diagram illustrating one example of the data processing module 410 of FIG. 6, in accordance with various aspects and embodiments of the present disclosure.

FIG. 8(a) depicts one example of data splitting of an intensity-versus-time signal in the form of a total ion chromatography (TIC) to generate split data subsets, each data subset corresponding to a test sample, in accordance with various aspects and embodiments of the present disclosure.

FIG. 8(b) depicts one example of a m/z scan profile corresponding to one single data point of the total ion chromatography (full scan) according to FIG. 8(a).

FIG. 9 depicts one example of the generated data subsets generated from data splitting and the sample-dataset correlation, in accordance with various aspects and embodiments of the present disclosure.

FIG. 10 illustrates one example of the compound file comprising information of one or more target compounds for each test sample, in accordance with various aspects and embodiments of the present disclosure.

FIG. 11 illustrates examples of original mass spectrum, background mass spectrum, and background-subtracted mass spectrum, generated by the data processing system 400.

FIG. 12(a) illustrates one example application of a validation rule to determine a negative mass shift, in accordance with various aspects and embodiments of the present disclosure.

FIG. 12(b) illustrates one example application of a validation rule to determine a positive mass shift, in accordance with various aspects and embodiments of the present disclosure.

FIG. 12(c) illustrates one example application of a validation rule, under which, a measured isotopic distribution and a theoretical isotopic distribution are compared for identifying abnormal samples.

FIG. 13 illustrates one example of the heat map produced by the visualization module, in accordance with various aspects and embodiments of the present disclosure.

FIG. 14 is a schematic diagram illustrating exemplary control signal exchanges between components of a mass analysis system in accordance with various aspects and embodiments of the present disclosure.

FIG. 15 is a flowchart illustrating one example method for analyzing a collection of substance samples, in accordance with various aspects and embodiments of the present disclosure.

FIG. 16 is a flowchart illustrating one example operation of FIG. 15 for conducting an automatic data processing process, in accordance with various aspects and embodiments of the present disclosure.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Selected Definitions

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It will be appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6, or ≥7, etc. of said members, and up to all said members.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure.

As used herein, an “isotope cluster” or “isotope pattern” or “m/z isotope pattern” or “isotopic distribution” refers to a grouping of intensity peaks associated with a single compound or a ionized species, where the compound or the ionized species that forms the isotope cluster can be isotopically enriched. The isotope cluster can include a single main peak (or main isotope peak) and two or more side peaks. The side peaks are generally of lower intensity than the main isotope peak, and can be both down-mass and up-mass of the main isotope peak. Although the separation between the main peak and side peaks can be measured in whole numbers, for example, 1, 2, 3, etc. Daltons 20 (“Da”), the separation may also be measured as non-whole numbers, for example, 0.5, 1.2, etc. For example, an isotope cluster with a main peak at “X” Da can include the intensity contribution of one or more additional peaks, e.g., at “X+1” Da, “X+2” Da, . . . .

As used herein, “intensity” refers to the height of, or area under, a MS peak. For example, the peak can be output data from a measurement occurring in a mass spectrometer (e.g., as a mass to charge ratio (m/z)). The charge “z” represents a charge state of the isotope cluster. The value of the charge state can be any positive or negative integer, such as +1, +2, +3, or −1, −2, or −3. In accordance with some embodiments of the present disclosure, intensity information can be presented as a maximum height of the summary peak or a maximum area under the summary peak representing a m/z value.

In the following passages, different aspects of the present disclosure are defined in more detail. Each aspect so defined may be combined with any other aspect or aspects unless clearly indicated to the contrary.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure, and form different embodiments, as would be understood by those in the art. For example, in the appended claims, any of the claimed embodiments can be used in any combination.

In the present disclosure, reference is made to the accompanying drawings that form a part hereof, and in which are shown by way of illustration only of specific embodiments in which the present disclosure may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

### System for Mass Analysis

The present disclosure generally relates to high throughput systems and methods for analyzing a collection of substance samples using mass spectrometry. Conventionally, the preparation and introduction of sample into a mass spectrometer is a relatively time-consuming process, particularly where rapid and efficient analysis of a sample pool containing multiple samples, which may or may not be analytically related, is desired. For instance, multiple different systems may have been used that were provided and controlled by separate entities and/or devices. For example, a liquid handling system would be used for preparation of samples, an ejection system would be used for ejecting samples into a port or interface, and mass spectrometry system would be used for the actual analysis of the samples. Each system needs to be separately controlled and operated, which lead to significant challenges and inefficiencies, including requirement of manual interaction and intervention for many of the operations.

The systems provided in the present disclosure advantageously include a central control system that is able to orchestrate and control the underlying subsystems used in the sample analysis process. For example, a script or set of operations may be generated at the central control system or controller that allows for control of the subsystems such that the subsystems are able to work synchronously across different types of operations performed by each of the subsystems. To accomplish such synchronicity across the subsystems, additional mechanical devices, such as robotics, may be incorporated into the overall system to handle transitions of materials between the systems. Thus, the central controller is able to interface with the various subsystems and transition robotics to more efficiently control each of the operations performed by the subsystems. Furthermore, the present systems advantageously include a computing subsystem and various functional modules thereof configured to efficiently process the data generated from multiple samples, reliably determine the data-sample correlation for a large pool of samples, generate mass spectra for each test sample, analyze the generated mass spectra, and provide real-time feedback to other subsystems. As a result, the efficiency and productivity of the entire system may be improved.

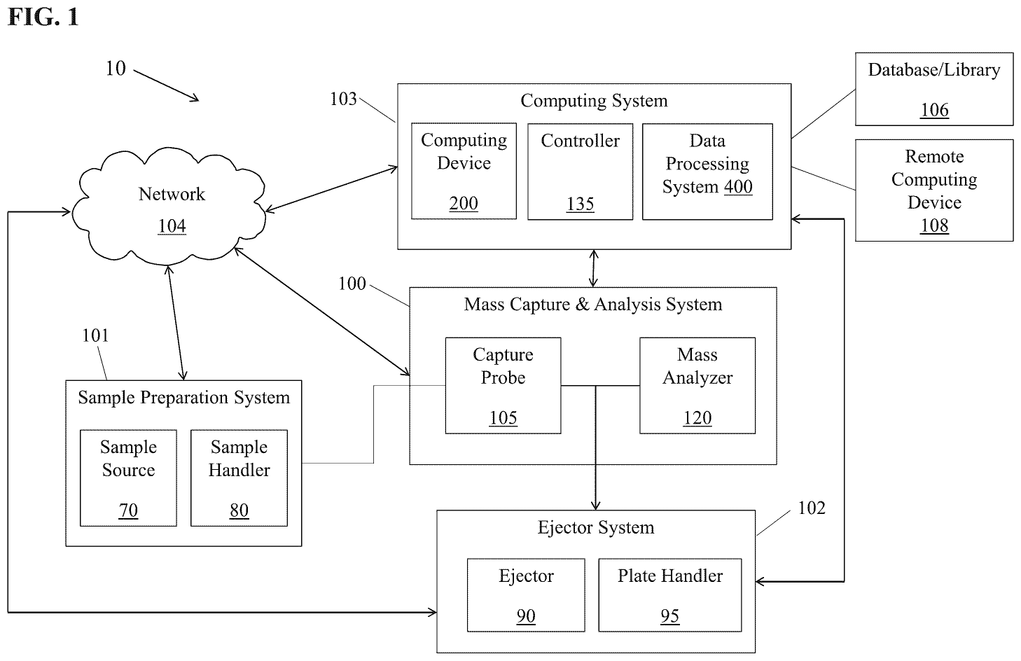

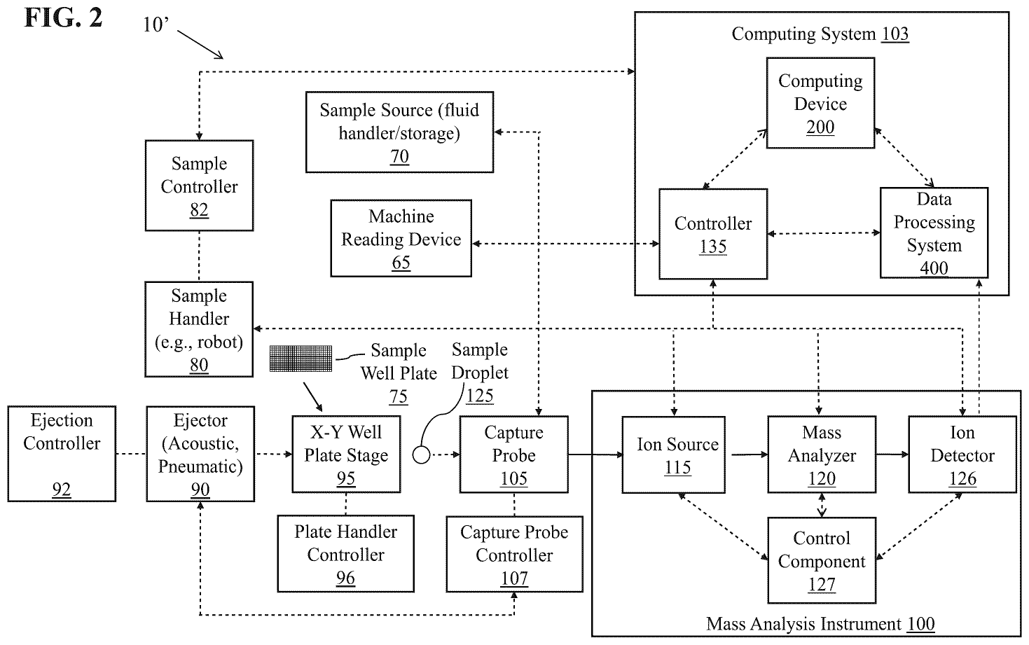

Now referring to FIGS. 1-2, examples of the present system will be illustrated and described. The descriptions of FIGS. 1-2 are concurrent unless otherwise noted. In the illustrated examples, the system 10 or 10′ can each include, in various combinations, pluralities of components, including some or all of: a mass capture and analysis system 100, a sample preparation system 101, an ejector system 102, a computing system 103, a network 104, a database/library 106, and a remote computing device 108. In the example illustrated in FIG. 1, various systems 100, 101, 102, 103, 104, and 106 are subsystems of the system 10 and may be operably connected between or among each other. For example, the computing system 103 is in bilateral communication with the mass capture and analysis system 100, and is also in bilateral communication with the ejector system 102; the sample preparation system 101 is in communication with the mass capture and analysis system 100, and is also in communication with the ejector system 102; the mass capture and analysis system 100 is in communication with the ejector system 102; and the database 106 and the remote computing device 108 are each in communication with the computing system 103.

In some examples, the mass capture and analysis system 100 may be a mass analysis instrument 100. The mass capture and analysis system 100 may be a mass spectrometer system including a mass analyzer 120 for analyzing ions generated from ionization of a sample. The mass capture and analysis system 100 may also include a capture device or probe 105 that captures the sample and provides the sample to other components of the mass capture and analysis system 100. In other examples (such as shown in FIG. 2), the capture probe 105 may be located externally from the mass analysis instrument 100. For instance, the capture probe 105 may be part of the ejection system 102.

It will also be appreciated by a person skilled in the art and in light of the teachings herein that the mass analyzer 120 can have a variety of configurations. Generally, the mass analyzer 120 is configured to process (e.g., filter, sort, dissociate, detect, etc.) sample ions generated by the ion source 115. By way of non-limiting example, the mass analyzer 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003; 17: 1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization source 115 and the mass analyzer detector 120 and is configured to separate ions based on their mobility difference between in high-field and low-field). Additionally, it will be appreciated that the mass analyzer 120 can comprise a detector 126 that can detect the ions that pass through the analyzer 120 and can, for example, supply a signal indicative of the number of ions per second that are detected.

The sample preparation system 101 may include a sample source 70 and a sample handler 80. The sample source 70 and a sample handler 80 are operative to retrieve collections of samples from the sample source(s) and to deliver the retrieved collections to capture locations associated with sample capture probes 105. The systems may be operative to independently capture selected ones of the pluralities of samples at the capture locations from the pluralities of samples, to optionally dilute the samples and to transfer the captured samples to mass analysis instruments 100, 120 for mass analysis. In some embodiments, the sample source 70 may include a set of well plates in a storage housing and/or liquid for adding to well plates. The sample source 70 may include part of a liquid handling system that manipulates and/or injects liquid into the well plates. The sample handler 80 includes one or more electro-mechanical devices (e.g., robotics, conveyor belts, stages, etc.) that are capable of transferring the samples (e.g., well plates) from the sample source to other components of the sample preparation system 101 and/or to other systems, such as the ejection system 102 and/or the capture probe 105. As an example, the sample handler 80 may transfer a well plate from the sample preparation system 101 to the ejection system 102. More specifically, the sample handler 80 may transfer the well plate to a plate handler 95 of the ejection system 102. Accordingly, the sample preparation system 101 may also be referred to as a sample delivery system. In some examples, selected sample information (e.g. sample or compound ID, chemical structure of the target compound, or other sample information) could be obtained during the sample handling steps through the use of sample controller 82 and/or the sample handler 80, and communicated to the computing system 103 or the data processing system 400 thereof.

In addition to the plate handler 95, the ejection system 102 may include an ejector 90 that ejects droplets from the wells of the well plates. The ejector 90 may be any type of suitable ejector, such as an acoustic ejector, a pneumatic ejector, or other type of contactless ejector. In an example, the plate handler 95 receives a well plate from the sample handler 80. The plate handler 95 transports the plate to a capture location that may be aligned with the capture probe 105. Once in the capture location, the ejector 90 ejects droplets from one or more wells of the well plates. The plate handler 95 may include one or more electro-mechanical devices, such as a translation stage that translates the well plate in an x-y plane to align wells of the well plate with the ejector 90 and/or or the capture probe 105.

The computing system 103 includes computing resources, components, and modules that are operative to perform various functions including but not limited to: communicating with other subsystems, receiving and transmitting electrical signals with other subsystems or components thereof, receiving, responding to, and executing user instructions, performing calculations, processing raw data received from mass analyzer, performing splitting data, performing sample-dataset correlation, generating and analyzing mass spectrometry data, identifying, annotating, and assigning MS peaks of mass spectra, extracting spectral features from mass spectra, conducting library search, identifying analytes, and outputting analytical report to end users.

In some examples, the computing system 103 includes a computing device 200, a controller 135, and a data processing system 400. The computing device 200 may be in the form of electronic signal processors and operative to perform various computing functions. The controller 135 may be in the form of electronic signal processors and in electrical communication with other subsystems within the system 10 or 10′. The controller 135 is further configured to coordinate some or all of the operations of the pluralities of the various components of the system 10 or 10′. The data processing system 400 may include various components and modules operative to process mass spectrometry data and to provide real-time feedback to end users and other subsystems.

In some examples, a network 104 may be operably connected to any one or all of the subsystems or components in the system 10 or 10′. The network 104 is a communication network. In the exemplary embodiment, the network 104 is a wireless local area network (WLAN). The network 104 may be any suitable type of network and/or a combination of networks. The network 104 may be wired or wireless and of any communication protocol. The network 104 may include, without limitation, the Internet, a local area network (LAN), a wide area network (WAN), a wireless LAN (WLAN), a mesh network, a virtual private network (VPN), a cellular network, and/or any other network that allows system 104 to operate as described herein.

In some examples, the system 10 or 10′ may further include one or more library/database 106. The database 106 can be a commercial database, or a private database containing analytical information from previously analyzed samples, or a combination of both. The library/database 106 includes chemical knowledge of standard of known compounds stored therein, including but not limited to chemical formula or elemental composition, neutral mass, monoisotopic mass, or mass of internal fragments thereof. In some embodiments, the computer system 103 is operative to perform a search using the database 106 and/or to compare data produced by the data processing system 400 to the retrieved data from the database 106 (such as molecular mass information or spectral features) to facilitate mass analysis and/or analyte identification.

Also illustrated in FIG. 2 are components of a sample delivery system for use in combination with the mass analysis instrument 100. The sample delivery system includes at least a sample source 70 for supplying a plurality of samples, a sample handler 80 for delivering the plurality of samples to a capture location, and a capture probe 105 for independently capturing one or more samples of the plurality of samples. In some aspects, the sample delivery system may further include a stage 95 for locating each sample for the plurality of samples proximate to a capture surface of the capture probe 105 and an ejector 90 for selectively ejecting that located sample into the capture surface of the capture probe.

In operation, a sample delivery system (including sample source 70 and sample handler 80) can iteratively deliver independent samples from a plurality of samples (e.g., a sample from a well of a well plate 75) to the capture probe 105. The capture probe 105 can dilute and transport each such delivered sample to the ion source 115 disposed downstream of the capture probe 105 for ionizing the diluted sample. A mass analyzer 120 can receive generated ions from the ion source 115 for mass analysis. The mass analyzer 120 is operative to selectively separate ions of interest from generated ions received from the ion source 115 and to deliver the ions of interest to an ion detector 126 that generates a mass spectrometer signal indicative of detected ions to the data processing system 400. In some aspects, the separate ions of interest may be indicated in an analysis instruction associated with that sample. In some aspects, the separate ions of interest may be indicated in an analysis instruction identified by an indicia physically associated with the plurality of samples.

In some aspects, the system 10 or 10′ may further include the generation, assignment, and use of identifiers associated with collections of samples and/or individual samples, and incorporation by one or more of components 70, 80, 95, 105, 100, etc. of identifier readers. For instance, an identifier associated with a well plate may be read or scanned by a machine reading device 65 as it leaves the sample source 70 and/or when the well plate is received by the stage 95. In such aspects, the identifier(s) may be used by the system to associate a corresponding one or more sets of instructions for use by the mass analysis instrument 100, 120 when analyzing transported sample droplets 125. In some aspects, the identifier may include an indicia physically associated with the plurality of samples. In some aspects, the indicia may be readable by optical, electrical, magnetic or other non-contact reading means. Indicia or identifiers in accordance with such aspects of the disclosure can include any characters, symbols, or other devices suitable for use in adequately identifying samples, sample collections, and/or handling or analysis instructions suitable for use in implementing the various aspects and embodiments of the present disclosure.

Additional details regarding implementation and operation of system 10 or 10′ in accordance with various aspects and embodiments of the present disclosure can be explained with reference to the Figures. FIGS. 1 and 2 present system diagrams illustrating embodiments of a system 10 or 10′, each embodiment including a sample handler 80 and an associated controller 135, which may be, for example, a Biomek computer available from Beckman Coulter Life Sciences, is in operative communication with a mass analysis instrument 100 and a controller for the capture probe 105, which may include, for example, an a SciexOS® or Analyst® computer available from AB Sciex. The Analyst® or SciexOS® computer includes a control component 107 for the capture probe 105, represented for example by Sciex open port probe (OPP) (also referred to as an open port interface (OPI)) software, and a control component 127 for the mass analysis instrument 100, which may be the Analyst® computer. The mass analysis instrument 100 and capture probe controller 107 may be further in operative communication with an ejector 90 and an X-Y Well Plate Stage 95 and plate handler controller 96, which may be, for example, a liquid droplet ejector with embedded computer or processor. For the purposes of this application, these distributed controller components may collectively be considered to be a system controller, and depending upon the configuration may be centralized, or distributed as is the case here. For instance, one of the controllers or controller components may send signals to the other controllers to control the respective devices.

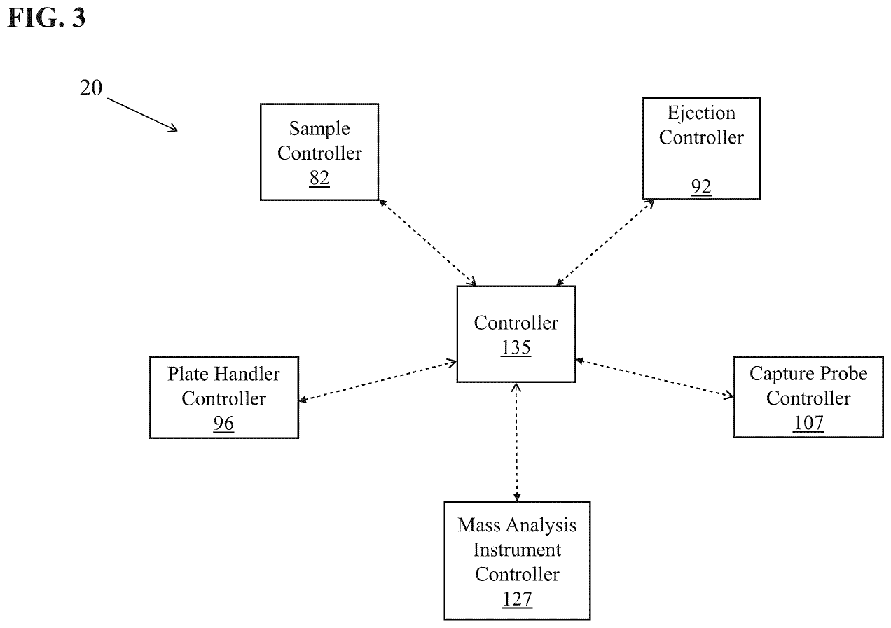

FIG. 3 illustrates one example of a centralized control system 20 for controlling the operation of the system 10 or 10′, according to FIGS. 1-2. In the illustrated example, the centralized control system 20 includes the controllers for each subsystem of the system 10 or 10′, including 135, 82, 92, 96, 107, and 127. The controller 135 may be a controller for the mass analysis instrument 100 and may be used as the primary controller for controlling components in addition to those components housed within the mass analysis instrument 100. As such, the controller 135 may be considered the main or central controller that orchestrates, or communicates with, the other controllers to carry out the operations discussed herein in a more efficient manner.

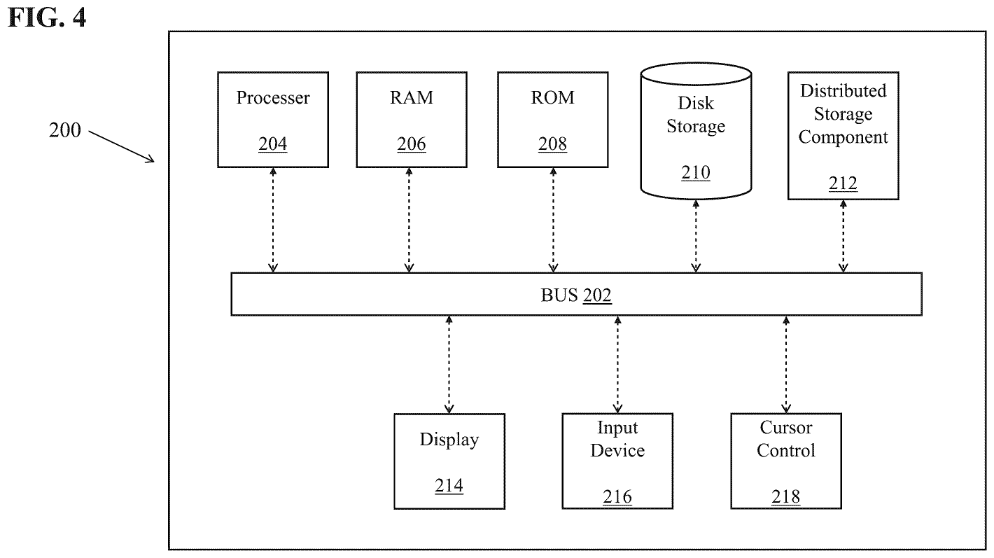

Now referring to FIG. 4, an exemplary example of the computing device 200 according to FIGS. 1-2 will be illustrated and described. It is noted that the computing system 103 of the system 10 or 10′ may include a single computing device 200 or may include a plurality of distributed computing devices 200 in operative communication with components of a mass analysis instrument 100. In the illustrated example of FIG. 4, the computing device(s) 200 may include a bus 202 or other communication mechanism of similar function for communicating information, and at least one processing element 204 coupled with bus 202 for processing information. As will be appreciated by those skilled in the relevant arts, such at least one processing element 204 may include a plurality of processing elements or cores, which may be packaged as a single processor or in a distributed arrangement. Furthermore, in some embodiments, a plurality of virtual processing elements 204 may be included in the computing device 200 to provide the control or management operations for the mass analysis instrument 100.

Computing device 200 may also include one or more volatile memory(ies) 206, which can for example include random access memory(ies) (RAM) or other dynamic memory component(s), coupled to one or more busses 202 for use by the at least one processing element 204. Computing device 200 may further include static, non-volatile memory(ies) 208, such as read only memory (ROM) or other static memory components, coupled to busses 202 for storing information and instructions for use by the at least one processing element 204. A storage component 210, such as a storage disk or storage memory, may be provided for storing information and instructions for use by the at least one processing element 204. As will be appreciated, in some embodiments the computing device 200 may include a distributed storage component 212, such as a networked disk or other storage resource available to the computing device 200.

Computing device 200 may be coupled to one or more displays 214 for displaying information to a computer user. Optional user input devices 216, such as a keyboard and/or touchscreen, may be coupled to a bus for communicating information and command selections to the at least one processing element 204. An optional graphical input device 218, such as a mouse, a trackball or cursor direction keys for communicating graphical user interface information and command selections to the at least one processing element. The computing device 200 may further include an input/output (I/O) component, such as a serial connection, digital connection, network connection, or other input/output component for allowing intercommunication with other computing components and the various components of the mass analysis instrument 100.

In various embodiments, computing device 200 can be connected to one or more other computer systems a network to form a networked system. Such networks can for example include one or more private networks, or public networks such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass analysis instrument 100 may be supported by operation of the distributed computing systems.

Computing device 200 may be operative to control operation of the components of the mass analysis instrument 100 and the sample delivery components 70, 80, 95, 105 through controller(s) 135 and to handle data generated by components of the mass analysis instrument 100 through the data processing system 400. In some embodiments, analysis results are provided by computing device 200 in response to the at least one processing element 204 executing instructions contained in memory 206 or 208 and performing operations on data received from the mass analysis instrument 100. Execution of instructions contained in memory 206 or 208 by the at least one processing element 204 can render the mass analysis instrument 100 and associated sample delivery components operative to perform methods described herein. Alternatively, hard-wired circuitry may be used in place of or in combination with software instructions to implement the present teachings. Thus, implementations of the present teachings are not limited to any specific combination of hardware circuitry and software.

The term “computer-readable medium” as used herein refers to any media that participates in providing instructions to processor 204 for execution. Such a medium may take many forms, including but not limited to, non-volatile media, volatile media, and transmission media. Non-volatile media includes, for example, optical or magnetic disks, such as disk storage 210. Volatile media includes dynamic memory, such as memory 206. Transmission media includes coaxial cables, copper wire, and fiber optics, including the wires that include bus 202.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 204 for execution. For example, the instructions may initially be carried on the magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector coupled to bus 202 can receive the data carried in the infra-red signal and place the data on bus 202. Bus 202 carries the data to memory 206, from which processor 204 retrieves and executes the instructions. The instructions received by memory 206 may optionally be stored on storage device 210 either before or after execution by processor 204.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

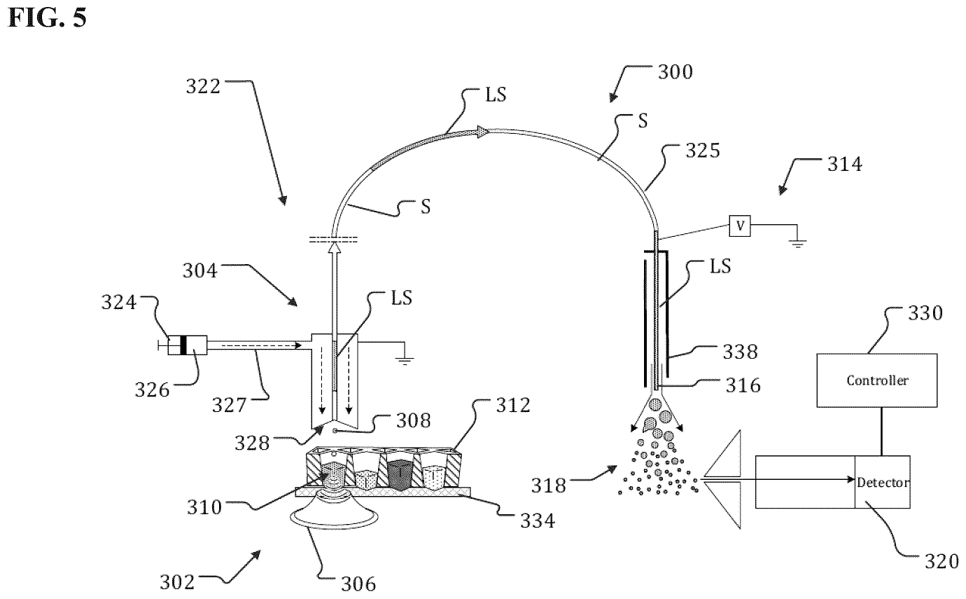

FIG. 5 depicts a schematic view of an example system 300 combining an acoustic droplet ejection (ADE) device 302 with an open port interface (OPI) 304 and an electrospray ionization (ESI) device source 314. The system 300 provides an example of an integration and physical connection between the ejection system 102, the capture probe 105, and the mass analysis instrument 100.

The ADE 302 includes an acoustic ejector 306 that is configured to eject a droplet 308 from a reservoir 312 into the open end of sampling OPI 304. The acoustic ejector 306 is one example of the ejector 90, and the sampling OPI 304 is one example of the capture probe 105. As shown in FIG. 5, the example system 300 generally includes the sampling OPI 304 in liquid communication with the ESI source 314 for discharging a liquid containing one or more sample analytes (e.g., via electrospray electrode 316) into an ionization chamber 318, and a mass analyzer detector (depicted generally at 320) in communication with the ionization chamber 318 for downstream processing and/or detection of ions generated by the ESI source 314. The ESI source 314 is an example of the ion source 115, and the mass analyzer detector 320 is an example of the ion detector 126.

Due to the configuration of the nebulizer probe 338 and electrospray electrode 316 of the ESI source 314, samples ejected therefrom are in the gas phase. A liquid handling system 322 (e.g., including one or more pumps 324 and one or more conduits 325) provides for the flow of a transport liquid from a solvent reservoir 326 to the sampling OPI 304 and from the sampling OPI 304 to the ESI source 314. The solvent reservoir 326 (e.g., containing a liquid, desorption solvent) can be liquidly coupled to the sampling OPI 304 via a supply conduit 327 through which the transport liquid can be delivered at a selected volumetric rate by the pump 324 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. The flow of transport liquid into and out of the sampling OPI 304 occurs within a sample space accessible at the open end such that one or more droplets 308 can be introduced into the liquid boundary 328 at the sample tip and subsequently delivered to the ESI source 314.

The ADE 302 is configured to generate acoustic energy that is applied to a liquid contained within a well or reservoir 310 of a well plate 312 that causes one or more droplets 308 to be ejected from the reservoir 310 into the open end of the sampling OPI 304. The well plate 312 is an example of the well plates 75 discussed above. The acoustic energy is generated from an acoustic ejector 306, which is an example of the ejector 90 discussed above. The well plate 312 may reside on a movable stage 334, which is an example of the plate stage 95 discussed above.

A controller 330 can be operatively coupled to the ADE 302 and can be configured to operate any aspect of the ADE 302 (e.g., focusing structures, acoustic ejector 306, automation elements for moving a movable stage 334 so as to position a reservoir 310 into alignment with the acoustic ejector 306 and/or the OPI 304, etc.). This enables the ADE 302 to eject droplets 308 into the sampling OPI 304 as otherwise discussed herein substantially continuously or for selected portions of an experimental protocol by way of non-limiting example. Controller 330 can be, but is not limited to, a microcontroller, a computer, a microprocessor, or any device capable of sending and receiving control signals and data. Wired or wireless connections between the controller 330 and the remaining elements of the system 300 are not depicted but would be apparent to a person of skill in the art. The controller 330 may be any of the controllers discussed above and may be responsible for controlling the mass analysis instrument 100 and/or the sample delivery system 101 as well.

As shown in FIG. 5, the ESI source 314 can include a source 336 of pressurized gas (e.g., nitrogen, air, or a noble gas) that supplies a high velocity nebulizing gas flow to the nebulizer probe 338 that surrounds the outlet end of the electrospray electrode 316. As depicted, the electrospray electrode 316 protrudes from a distal end of the nebulizer probe 338. The pressured gas interacts with the liquid discharged from the electrospray electrode 316 to enhance the formation of the sample plume and the ion release within the plume for sampling by mass analyzer detector 320, e.g., via the interaction of the high-speed nebulizing flow and jet of liquid sample. The liquid discharged may include discrete volumes of liquid samples LS received from each reservoir 310 of the well plate 312. Each received liquid sample LS is instantly diluted by a solvent after being captured within the OPI, with a dilution factor of about 1000 times (as flow of the solvent moves the liquid samples LS from the OPI 304 to the ESI source 314, the solvent is also referred to herein as the transport liquid). The nebulizer gas can be supplied at a variety of flow rates, for example, in a range from about 0.1 L/min to about 20 L/min, which can also be controlled under the influence of controller 330 (e.g., via opening and/or closing valve 340).

It will be appreciated that the flow rate of the nebulizer gas can be adjusted (e.g., under the influence of controller 330) such that the flow rate of liquid within the sampling OPI 304 can be adjusted based, for example, on suction/aspiration force generated by the interaction of the nebulizer gas and the analyte-solvent dilution as it is being discharged from the electrospray electrode 316 (e.g., due to the Venturi effect). The ionization chamber 318 can be maintained at atmospheric pressure, though in some examples, the ionization chamber 318 can be evacuated to a pressure lower than atmospheric pressure.

### Automatic Data Processing

As discussed above, the present systems may be operative to analyze a large collection of substance samples and generate a large quantity of mass spectrometry data in a high throughput fashion. For example, one sample per second, or more than 50,000 samples per day. System 10 or 10′ according to the present disclosure advantageously provides an auto-triggered data processing function to avoid potential issues arising from the assay throughput bottleneck, to maintain a constant workflow of operations, to perform data processing and acquisition with matched speed as sample analysis, and to improve the overall productivity of the system. The auto-triggered data processing function may be realized by the data processing system 400 of the system 10 or 10′.

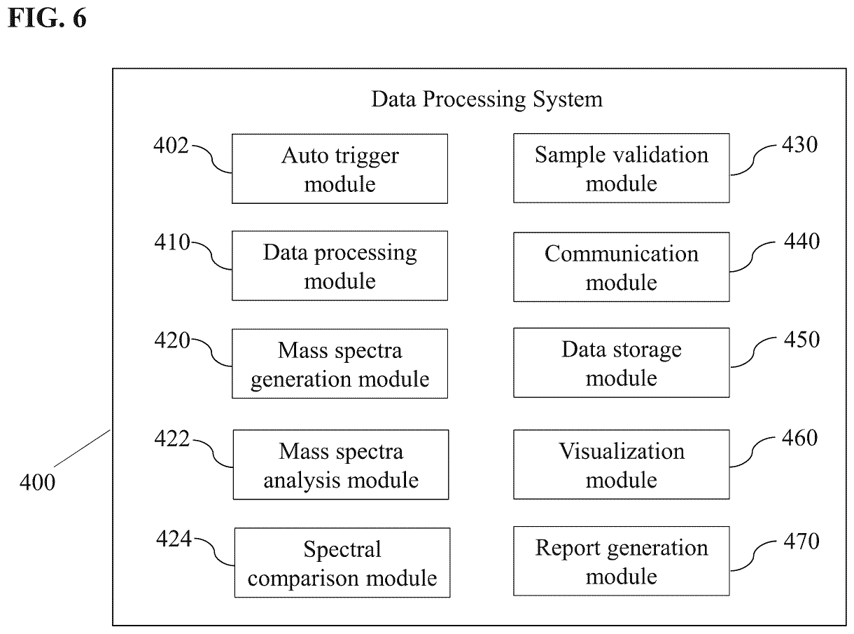

Now referring to FIG. 6, one exemplary example of the data processing system 400 to be utilized in FIGS. 1-2 will be illustrated and described. In the illustrated example, the data processing system 400 includes one or more or all of the following modules: an auto trigger module 402, a data processing module 410, a mass spectra generation module 420, a mass spectra analysis module 422, a spectral comparison module 424, a sample validation module 430, a communication module 440, a data storage module 450, a visualization module 460, and a report generation module 470. The various modules included in the data processing system 400 may be operatively connected or interconnected among each other. Each module of the data processing system 400 may be operatively connected to other components or subsystems of the system 10 or 10′.

In some embodiments, the data processing system 400 includes an auto trigger module 402 operative to automatically start processing data upon reception of mass spectrometry data generated by the mass analysis instrument 100. During operation of the system 10 or 10′ for analyzing a collection of samples, due to the high data acquisition speed, mass spectral signals from different ejections (e.g., different wells of the same well plate) are collected within the same operation, which may generate a single large mass spectrometry dataset that contains a compilation of data subsets, each data subset corresponding to an individual test sample ejected from the sample well plate. The mass spectrometry dataset or any subsets thereof include primarily raw mass spectral signals, e.g., an intensity-versus-time signal, which is unsplit and unprocessed. Once the mass analysis instrument 100 completes analysis of all test samples, a signal indicative of the completion of the data acquisition and generation of the mass spectrometry dataset will be transmitted to the computing system 103. In response, the auto trigger module 402 is operative to trigger the data processing module 410 to start processing the mass spectrometry dataset received from the mass analysis instrument 100.

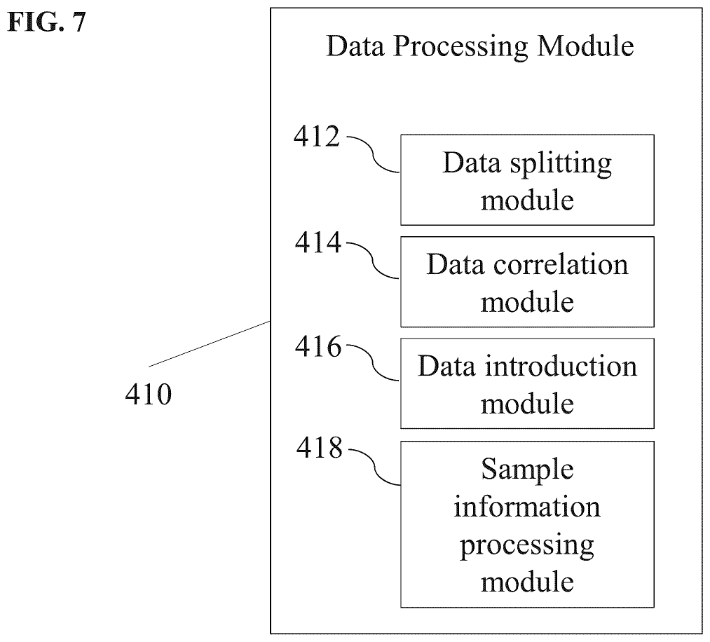

Now referring to FIG. 7, an exemplary example of the data processing module 410 will be illustrated and described. In the illustrated example, the data processing module 410 includes a data splitting module, 412, a data correlation module 414, a data introduction module 416, and a sample information processing module 418. As discussed above, when triggered by the auto trigger module, the data processing module 410 starts processing the mass spectrometry dataset received from the mass analysis instrument 100. The data splitting module 412 is operative to split the mass spectrometry dataset and generate a plurality of split data subsets, each data subset corresponding to one test sample ejected from the associated well of the well plates.

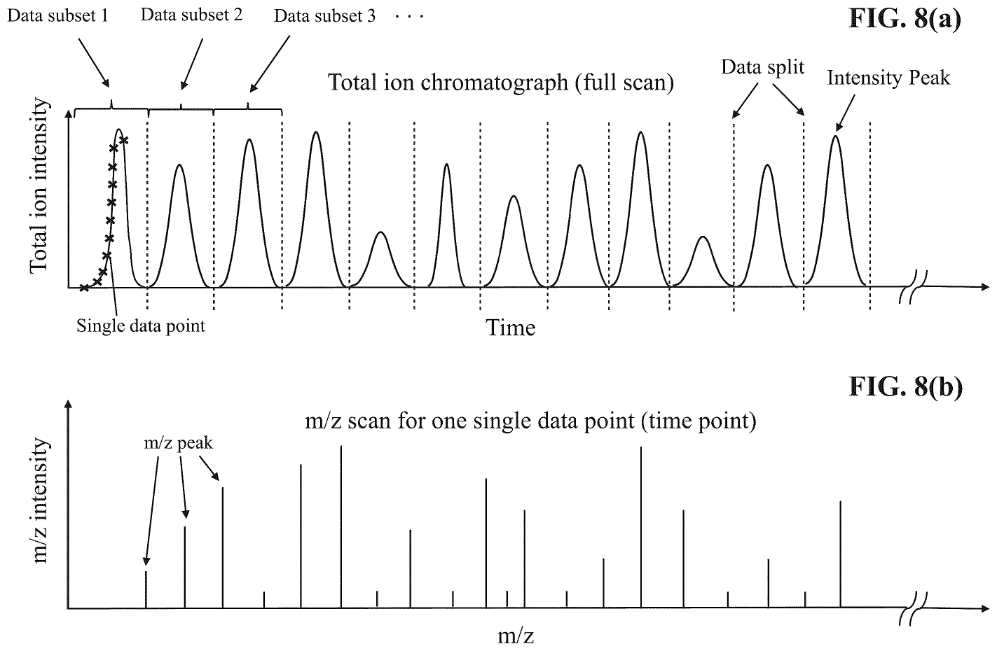

In some embodiments, the mass spectrometry dataset to be split by the data splitting module 412 is in a form of an intensity-versus-time signal. The intensity-versus-time signal contains a plurality of intensity peaks. The intensity represents the ion intensity of the ionization products derived from each sample. As an exemplary example, the intensity-versus-time signal may be in a form of Total Ion Current Chromatography (TIC). A TIC as used herein refers to a chromatogram created by summing up intensities of all mass spectral signals belonging to the full scan of all samples from the sample collection. Note that the TIC includes background noise as well as sample components. An exemplary example of TIC is shown in FIG. 8(a). The TIC includes a plurality of intensity peaks, each intensity peak corresponding to a data subset, e.g., data subset 1, data subset 2, data subset 3, . . . , and each dataset corresponding to the sum of intensities of all mass spectral signals belonging to one individual test sample ejected from the well plate 75 and introduced to the mass analysis instrument 100. Each data subset of the TIC further contains a plurality of datapoints, each datapoint including the sum of the ion intensities of the total mass spectral signals obtained from the m/z scan of the entire m/z range at that time point. An exemplary example of the m/z scan profile for one single data point is illustrated in FIG. 8(b). During operation, the data splitting module 412 is operative to identify the boundary between the intensity peaks or the corresponding data subsets, and to split the TIC into individual data subsets at the boundaries, with each split intensity peak or sub dataset consisting of the mass spectral signals associated with the corresponding test sample.

The data correlation module 414 is operative to correlate each of the split data subsets generated by the data splitting module 412 to the corresponding test sample or the well position of the test sample. In some embodiments, the sample-intensity peak correlation or sample-dataset correlation is performed by the data correlation module 414 based on the time information recorded in the log. The time information includes but is not limited to: timing of acoustic ejection for each test sample from the well plate, timing of the introduction of ejected sample droplet into the mass analysis instrument, and timing of the start and end of the m/z scan, etc.

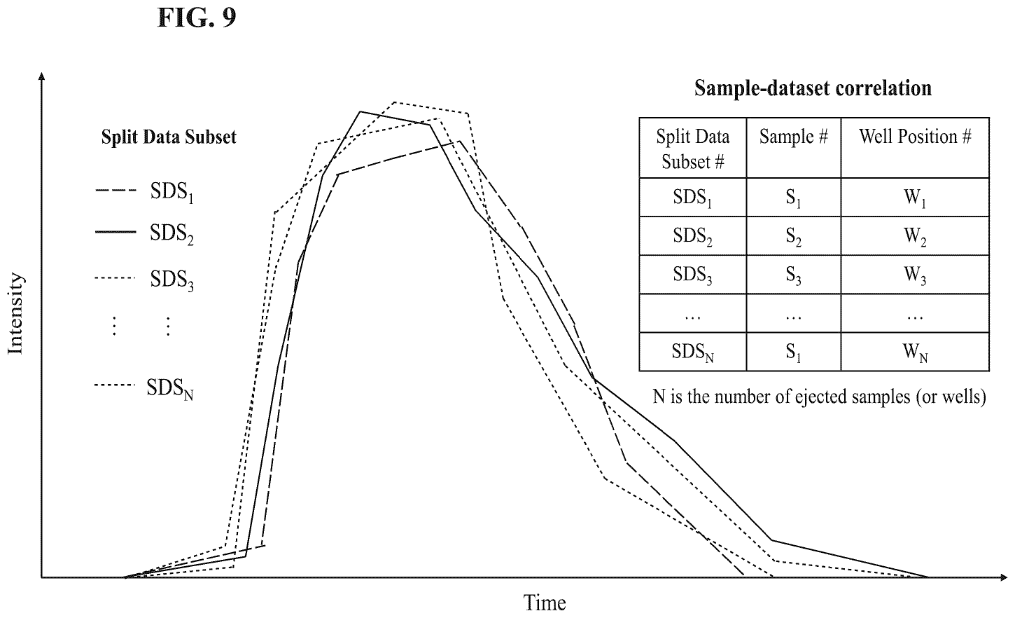

FIG. 9 illustrates one example correlation of the split intensity peaks of an intensity-versus-time signal to the test sample or well position of the sample. As can be seen, each intensity peak represents a split data subset that corresponds to a particular test sample or a particular well position where the sample is ejected from. In some embodiments, the sample-dataset correlation performed by module 414 may result in a number of correlated sample-dataset pairs, wherein the number is the total number (N) of the test samples or the total number (N) of the wells containing the test samples. An example well plate may have a total of 96, or 384, or 1,536, or other number of wells. Upon data splitting and correlation, the raw mass spectrometry dataset generated from high throughput analysis, however large, can be efficiently converted into distinct data subsets correlated with each single test sample with high precision and accuracy.

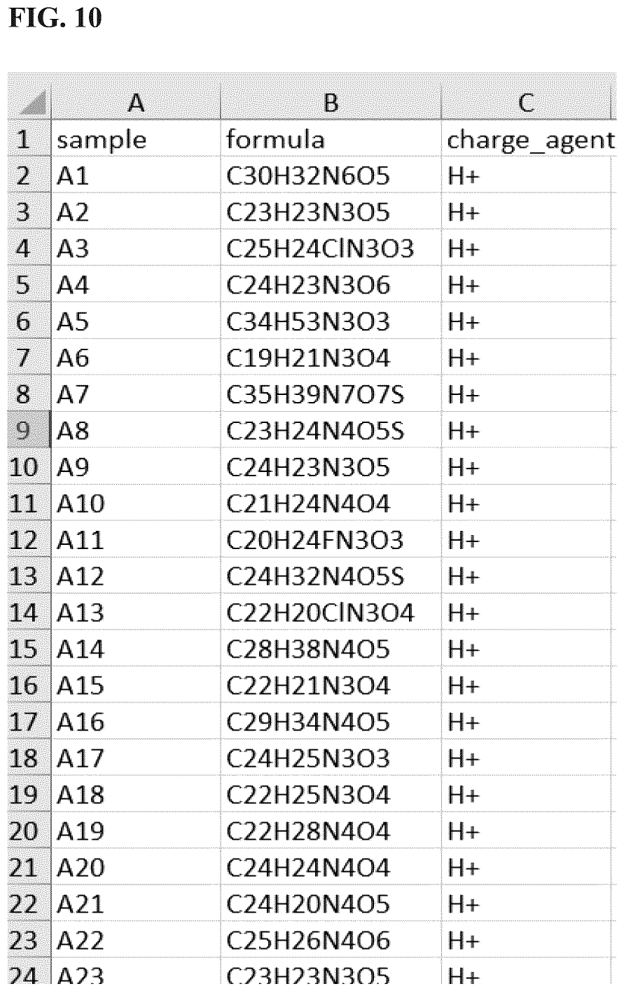

Now referring back to FIG. 7, the data processing module 410 may include a data introduction module 416 operative to introduce a compound file comprising information of one or more target compounds for each test sample analyzed by the mass analysis instrument 100. The compound file may include a standard or reference mass spectrum, chemical formula, theoretical molecular mass, expected m/z peaks, expected mass spectral features, MS/MS features, compound ID, or other chemical knowledge related to the target compound with respect to each sample. The compound file may further include information regarding possible interfering compounds related to the target compound, including but not limited to degradation products, deterioration products, metabolites, etc. The data introduction module 416 is further operative to correlate the compound file to the split data subsets with respect to each test sample. An example of compound file is illustrated in FIG. 10. As can be seen, the chemical formula and charge agent of the target compound(s) are provided with respect to each sample ID (or well position number).

In some embodiments, the data processing module 410 further includes a sample information processing module 418 operative to introduce sample information with respect to each test sample. Such information may include sample ID, sample description, sample lot number, sample origination information, scan number, time information, etc. The sample information may also include a method file for the test sample. In some examples, selected sample information described herein may be collected/obtained during the sample handling stage through the use of the sample handler 80 and/or the sample controller 82, then communicated to the computing system 103, and introduced to the data processing system 400. In some embodiments, the sample information processing module 418 is further operative to correlate such information to the split data subsets with respect to each test sample and to compile all information related to the same test sample.

Now referring back to FIG. 6, the data processing system 400 may include a mass spectra generation module 420 operative to generate a mass spectrum from the split data subset with respect to each sample. Each mass spectrum includes the m/z peaks of all ionization products derived from the correlated test sample. In some embodiments, the mass spectra generation module 422 is further operative to generate a background mass spectrum. As discussed above, the mass spectrometry dataset (such as TIC) may contain both signals derived from the test samples and background or noise. In some examples, the data processing system 400 is operative to remove the background or background signals from the mass spectrum. The background mass spectrum may be derived from analyzing of a blank sample, e.g., a blank well, a solvent, or a control that is free from the test sample or a target compound. The background mass spectrum may include selected m/z peaks known to be background or noise signals, or m/z peaks from carrier flow ions, or m/z peaks from solvent, or any combinations thereof.

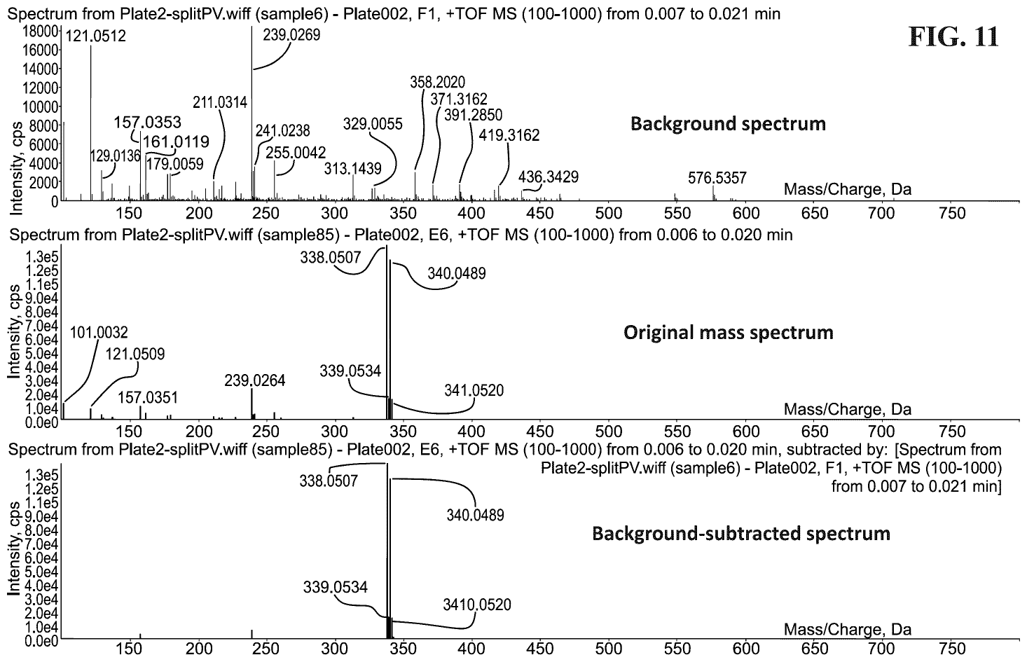

The data processing system 400 may further include a mass spectra analysis module 422. The mass spectra analysis module 422 is operative to subtract the background spectrum or background signals from the original mass spectrum of each test sample to obtain a background-subtracted mass spectrum for each test sample. Background subtraction may improve the quality of the mass spectrum and the accuracy of peak assignment and analyte identification. An example of background subtraction operated by the mass spectra analysis module 422 is further explained in FIG. 11, where the original mass spectrum, background spectrum, and the background-subtracted spectrum are illustrated and compared.

The mass spectra analysis module 422 is operative to analyze the mass spectrum or the background-subtracted mass spectrum against the corresponding compound file which contains the information of the target compounds. The analysis of the mass spectrum by the mass spectra analysis module 422 includes one or more of the following operations: identifying m/z peaks over a predetermined cut-off peak intensity, annotating the m/z peaks, identifying isotopic clusters, matching the isotopic pattern with the predicted or expected pattern, determining charge state, calculating average molecular mass, monoisotopic molecular mass, neutral mass, grouping related m/z peaks, identifying pattern(s) of related m/z peaks, calculating the mass difference between or among m/z peaks, extracting spectral features such as peak patterns and relative peak intensities, and so on.

The data processing system 400 may further include a spectral comparison module 424 operative to compare the mass spectrum or background-subtracted mass spectrum with a reference mass spectrum or extracted spectral features therefrom to determine the similarity and/or identifying the present or absence of a target compound in the test sample. The spectral comparison module 424 may be further operative to conduct a search in the library 106 for relevant compound information or spectral features relevant to the mass spectrum or background-subtracted mass spectrum of the test sample. In some examples, operation of the data processing system 400 or any module thereof may identify analytes in the test sample, and/or determine the similarity of the identified analytes to the target compound(s) with respect to the test sample.

The data processing system 400 may further include a sample validation module 430 operative identify abnormal samples, among the test samples, based on one or more validation rules. Validation performed by module 430 may validate the test samples, determine the validity of the ejection/well, reduce the false information induced by interference, and improve the confidence of compound identification for the test sample.

In one particular embodiment, the sample validation module 430 employs a first validation rule, under which each of the abnormal samples has a mass shift greater than a threshold mass shift. In another particular embodiment, the sample validation module 430 employs a second validation rule, under which each of the abnormal samples has an isotope pattern distribution similarity smaller than a threshold isotope pattern distribution similarity.

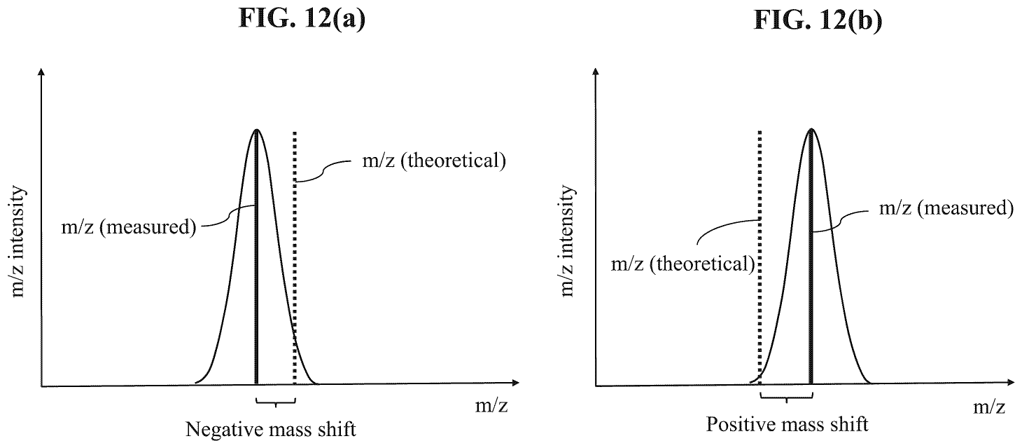

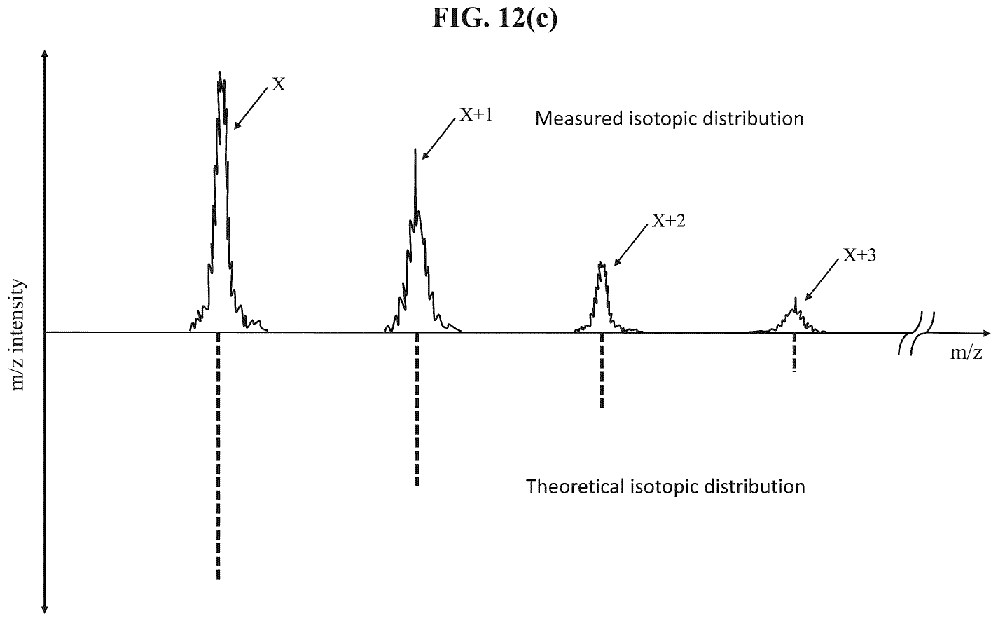

FIGS. 12(a) and 12(b) illustrate examples of implementation of the first validation rule in determining the abnormal sample. As shown in FIG. 12(a), a mass spectrum generated from a test sample includes an isotopic pattern. The isotopic pattern has a measured m/z, typically as an averaged m/z of the isotopic pattern. The measured m/z is compared with a theoretical (or expected) m/z according to the following equation (I) to calculate a mass shift in ppm:

$$mass shift = \frac{\frac{m}{z} ( measured ) - \frac{m}{z} ( theoretical )}{\frac{m}{z} ( theoretical )} * 1 {0}^{6} ( p p m ) \qquad ( Equation 1 )$$

If the mass shift calculated from Equation 1 is greater than a threshold mass shift, the sample may be deemed abnormal and may be flagged out for users to review. The threshold mass shift may have a pre-determined value, e.g., 1 ppm, 2 ppm, 3 ppm, 5 ppm, or 10 ppm, depending on the user's need. The type of mass shift shown in FIG. 12(a) is a negative shift, with the m/z(measured) less than the m/z(theoretical). Conversely, if the mass shift is of or less than the threshold mass shift, the test sample may be determined to be normal and validated.

As another example, a type of positive mass shift is shown in FIG. 12(b). Similarly, the sample will be invalidated if the mass shift is greater than a pre-determined threshold.

In some examples, mass shifts for isotopic patterns associated with all charge states common to a neutral mass across the entire m/z range are calculated and weighed in determining the validity of the related test sample.

FIG. 12(c) illustrates an example of application of the second validation rule through the use of the sample validation module 430. In the illustrated example, a mass spectrum generated from a test sample includes a measured isotopic distribution shown in the upper panel. The measured isotopic distribution comprises a plurality of detected isotopic m/z peaks, e.g., a main or most abundant m/z peak (e.g., X) and additional side m/z peaks, e.g., X+1, X+2, X+3, etc. The isotopic pattern has a theoretical distribution profile (shown in the lower panel), represented by the relative ratio of the peak intensities of the isotopic m/z peaks within the isotopic patter. The theoretical isotopic distribution for a particular target ion can be obtained by mathematical simulation, e.g., based on the known elemental composition and natural abundance of the constituent elements with respect to the target ion. The module 430 is operative to calculate a similarity score to determine the similarity of the measured distribution (e.g., experimental ratio of peak intensities) with the theoretical distribution (e.g., theoretical ratio of peak intensities obtained from simulation) for the particular isotopic pattern, based on a pre-determined mathematical fitting model or algorithm. If the similarity score is of or greater than a threshold similarity score, the sample may be determined to be normal and validated. Conversely, if the similarity score for the measured distribution is less than the threshold similarity score, the related sample may be determined as an abnormal sample and may be flagged out for users to review.

The data processing system 400 may further include a communication module 440 operative to prompt, to a user of the system, a notification of the abnormal samples determined using the sample validation module 430. The notification may be displayed on the display 214 of the computing device 200, or alternatively displayed on a remote computing device 108 operatively connected to the computing system 103.

The communication module 440 may be further operative to send a feedback message to the controller 135. The feedback message may be in a form of electrical signal indicative of the presence or suspicion of abnormal samples. The feedback message may also include any information related to the abnormal samples. The feedback message may be further transmitted to control components of other subsystems through the centralized control system 20 according to FIG. 3.

The communication module 440 may be further operative to send an instruction to controller components of other subsystems according to FIGS. 1-2 to adjust the operations of the sample ejector, the capture probe, the nebulizer nozzle, and the mass analysis instrument, based on the feedback message. For example, the communication module 440 may be operative to send an instruction to the ejection controller 92, upon a user instruction and optionally through the controller 135, to eject, independently, the identified abnormal samples from the well plate to re-analyze the abnormal samples using the mass analysis instrument 100. As another example, the communication module 440 may be operative to send an instruction to the mass analysis instrument controller 127 to trigger a fresh mass calibration, if the mass shift for the samples is determined by the sample validation module 430 to be below a predetermined threshold level. Reanalysis of the abnormal samples may be followed after the fresh mass calibration.

The data processing system 400 may further include a data storage module operative to store the various types of data described herein including but not limited to the MS dataset (raw data), split sub datasets, compound information file, generated mass spectra, background mass spectra, background-subtracted mass spectra, mass spectra analysis results, and abnormal sample information.

The data processing system 400 may further include a visualization module 460 operative to generate a heat map that depicts a characteristic of the samples as a function of the well position of the well plate, where test samples are ejected from. Some common characteristics that can be depicted in the visualized heat map include but are not limited to the total ion intensities for each sample, total ion intensity of a particular m/z peak, total ion intensity of m/z peaks related to a particular target ion, or total ion intensity of m/z peak(s) related to a target compound, signal-to-noise ratio (S/N), mass shift for a particular isotopic distribution, spectral similarity score, or a quality status of sample.

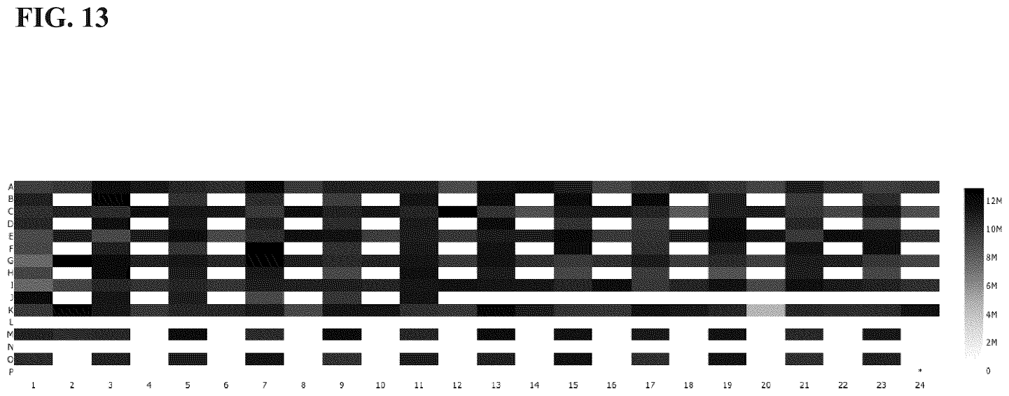

FIG. 13 illustrates a particular example of heat map generated by the visualization module 460. The heat map is a graphical representation of magnitude of total ion intensity of the test samples, where quantity value of the total ion intensity is represented in the coded/scaled bar on the side. The coded bar, either in color or in a grayscale, provides a visual indication of the total ion intensity, based on the color contrast or scaled differentiation. For example, a blue color or a dark code indicates a relatively high value of the total ion intensity; while a red color or a light code indicates a relatively low value of the total ion intensity. The heat map plots provide users a quick and direct overview of analysis results with respect to the total ion intensity, and help users to quickly identify suspicious or abnormal samples. The suspicious or abnormal samples could be flagged out or labeled with specific colors or marks to draw users' attention for further review. In another example, the heat map generated by the visualization module 460 may represent magnitude of mass shift for a particular isotopic distribution common to the test samples. In such embodiments, the scaled bar provides users a visual indication of the mass shift value and allows users to efficiently identify the plots that show a mass shift above a threshold value.

In other embodiments, multiple heat maps may be generated by the visualization module 460, with each heat map representing a distinct characteristic of the samples. In some examples, the different heat maps may each present a characteristic of a different group of target analytes within each well of the well plate. The generated heat maps can be provided on a user interface such as a graphic user interface (GUI), where a user may view the heat map and select any plots of interest to retrieve more information related to the selected plots and the corresponding sample.

The data processing system 400 may further include a report generation module 470 operative to generate a report for users. The report may include any result generated by or stored in the data processing system 400.

### Methods for Mass Analysis

In another aspects, the present disclosure relates to a method for analyzing a collection of substance samples by using the systems described herein. In accordance with various embodiments, instructions configured to be executed by a processing element to perform the present methods, and/or to render the system 10 or 10′ operative to carry out the present methods, in accordance with the disclosure can be stored on non-transitory computer-readable media accessible to the processing element.

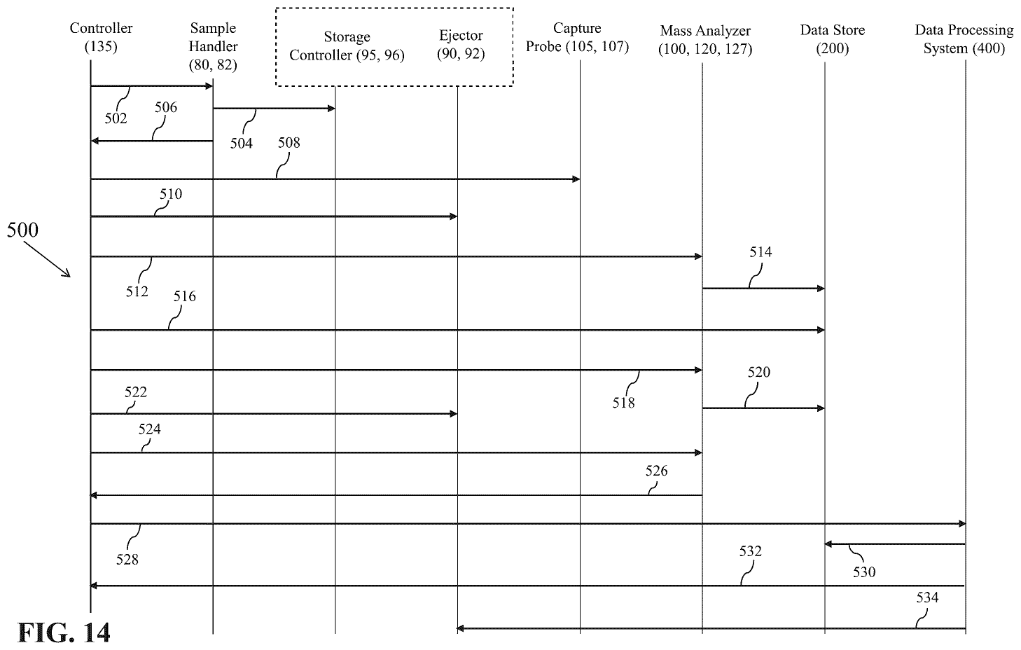

Examples of such methods can be explained through reference to the figures. For example, starting with the signal exchange diagram shown in FIG. 14, a process of moving a collection of substance samples on a microplate or well plate 75 from a sample source 70 to a capture location 110 for individual dispensing for group or individual analysis by a mass analysis instrument 100 can be described.

At 502, such an example method can begin with accessing, by an operator of a mass analysis system 10 or 10′, generated for a touchscreen or other display associated with a controller 135. By using a combination of graphical input devices, such as one or more mouses, trackballs, cursor direction keys, or pointing devices, and/or keyboards and touchscreens, for communicating graphical user interface information and command selections to the controller 135, such a user can invoke one or more analysis applications or programs to specify both one or more operational protocols to be applied with respect to one or more desired samples or sample collections, and cause controller(s) 135 to initiate semi- or fully-automatic analysis processes. Optionally, the operator can be enabled to monitor and optionally manually intervene in such analysis processes as the processes occur.

Selection by such an operator of a start command can, for example, cause a controller 135 at 502 to generate a sample retrieval signal configured to cause a sample handler 80 to retrieve one or more specified microplates 75 from a sample source 70 and ultimately have the microplate 75 delivered to a capture location 110, for selection and analysis of one or more specified samples.

At 504, on receipt of a sample retrieval signal, the sample handler 80 can poll one or more storage controllers of the sample source 70 for identifiers associated with locations at which the selected sample(s) can be retrieved, such as for example locations at which one or more corresponding microplates 75 can be retrieved.

Upon receipt of suitable location information, the sample handler 80 can cause suitably configured mechanical apparatus, to retrieve corresponding microplates 75 with the identified sample collection(s) from either or both of robotic arms and human operators for plate loading and unloading. Loading and unloading of the microplates 75 may be performed through one or more electromechanical devices. For instance, a first robotic device may remove the microplates from storage in the sample source 70, a second robotic device may transfer the microplate 75 to the ejection system, and a movable stage 95 may move the microplates to the capture location where samples can be ejected from the microplates.

As will be appreciated, the use of labels and/or other physical and/or virtual machine readable identifiers, or indicia, associated with individual samples and/or well plates 75 can be used to automate some or all of the process used by any or all of sample handler 80, storage controllers, ejector 90, capture probe 105, and/or mass analysis instrument 100 to deliver and subsequently analyzed sample(s) provided through process(es) 500.

When the desired sample collection(s) are in place in capture location, at 506 the sample handler 80 or the sample controller 82 that controls the sample handler 80 can transmit or route a suitably configured confirmation to the responsible controller 135.

On receipt at 506 that the sample collection is in a suitable capture location 110, at 508 the controller 135 can route or transmit to a capture probe 105 or a capture probe controller 107 any placement commands suitable for causing the capture probe 105 to be placed in an appropriate position for capturing the desired sample(s) 76 upon ejection from the well plate 75. For example, such a command can be adapted to move the probe 105 up or down along a Z-axis into a desired position above the microplate 75, or otherwise place it at a desired position from which it can appropriately collect ejected droplets from one or more wells of the microplate 75.

When the capture probe 105 is suitably disposed relative to the well or collection plate 75, at 510 the controller 135 can route or transmit to a sample ejector 90, such as an acoustic ejector, or an ejector controller 92 that controls the sample ejector 90, a sample ejection command configured to cause the ejector to eject the sample, or a portion thereof, such as a droplet, from the well for collection by the capture probe 105. For example, an acoustic ejector 105 can use radio-frequency (RF) energy to generate sound through use of a transducer focus assembly (TFA), which enables generation of focused ultrasound pulses near the surface of a specified sample in a collection plate and thereby cause a sample droplet of desired volume to be raised above the surface for capture.

When a sample of a desired collection has been ejected, at 512 the controller 135 can generate and transmit or route to a mass analysis instrument 100 or a control component 127 thereof an analysis command signal representing instructions configured to cause the analyzer to perform any desired mass analysis, using for example known mass analysis techniques. For example, any desired dilutants, solvents or other substances may be added, and the sample may be ionized, and then subjected to any desired analysis through use of suitable mass analysis components and systems. As one example, a delivery solvent (i.e. methanol) can be pumped into the instrument from a solvent bottle by a gear pump; a degasser may be used to remove any undesired air gaps or bubbles from the solvent line so as to maintain the accurate and consistent solvent flow, an OPI can generate a suitably balanced and consistent vortex to dissolve and extract the sample, and a consistent gas flow can be generated by ion source probe and electrode to pull the customer sample from the OPI into mass analysis instrument 100 for analysis.

Using any suitable mass analysis techniques, including for example known mass spectrometry techniques, at 514 the mass analyzer can generate and capture data representing the content of an analyzed sample, and store such data in temporary or persistent memory, including for example one or more data stores of a computing device 200 or a data storage module of the data processing system 400. Such data can, for example, be generated, sorted and otherwise processed, and stored in memory(ies) 206 by the mass analysis instrument 100, and/or at 516 controller(s) 135 can semi- or fully-automatically control such processing, and/or an operator of the system 10 or 10′ can manually control such processing through the use of a suitably-configured user interface.

In some examples, at least one of a plurality of collected samples can be associated with an identifier interpretable by the controller 135 or control components of other subsystems, by example through use of a machine reading device 65 such as a bar code or QR code reader, and configured to enable the controller to generate signals configured for causing at least one component 70, 80, 90, 95, 105, 100 of the system 10 or 10′ to perform at least one sample capture, sample transfer, dilution, dissolution, or mass analysis operation specific to the sample associated with the identifier.

In some examples, the controller(s) 135, 82, 92, 96, 107, and 127 are capable or adjusting any one or more operational settings of the mass analysis instrument, including for example sample identity, dilution parameters, ionization parameters, and spectrographic analysis parameters, as well as processes for generating and storing spectrographic data, based upon one or more analysis instructions associated with the at least one identifier. In other words, the at least one identifier may be associated with data representing a plurality of analysis instructions, and at least one of the plurality of analysis instructions is associated with a subset of the plurality of samples, and the controller 135, 82, 92, 96, 107, and 127 are operative to perform at least one of the sample capture, sample transfer, dilution, dissolution, or mass analysis operations based on at least one of the plurality of analysis instructions while the sample capture probe 90, 105 is capturing one of the subset of the plurality of samples.

In some examples, the sample capture probe 105 may include at least one sample ejector 90, which may be configured to independently eject a selected sample from the plurality of samples for capture by the sample capture probe; and may include a sample staging device 95 operative to position a next-selected sample for ejection by the sample ejector 105 subsequent to capture by a capture probe 105 of a previously-selected sample, so that samples may be continually analyzed by mass analyzer 100. For example, as shown in FIG. 14, at 518 a controller 135 can route to any or all of a sample handler 80, a storage controller 95, and/or a capture probe 105 a second command to select and retrieve a next-selected sample, cause it to be ejected, captured, and analyzed, and corresponding analysis data to be stored in data store 200 or 400 at 520.

The feature of configuring a sample ejector 90 to eject a next-selected sample 76 subsequent to capture by a capture probe 105 of a previously selected sample, so that samples may be continually analyzed by mass analyzer 100, is one example of the particular advantages offered by systems in accordance with the present disclosure. Using such a feature enables rapid analysis of multiple samples, which may or may not be analytically related. Such samples may, for example be multiple samples of a single substance; or they may be entirely unrelated in origin, method, and/or purpose of analysis.

In further embodiments, the present disclosure provides systems 10 or 10′comprising sample capture probes 105 comprising at least one sample ejector 90, which may be configured to eject a plurality of selected samples before positioning a next sample relative to the sample ejector. The feature of configuring a sample ejector 90 to eject multiple droplets of a single sample is an example of the particular advantages offered by systems in accordance with the present disclosure. Using such a feature enables, for example, the use of multiple analysis methods, protocols, or parameters to be used in testing a single sample, or to apply a single analysis method, etc., to a single, relatively highly heterogenous sample. For example, at 522 according to FIG. 9 a controller 135 can route to an ejector 90 a second ejection command, prior to instructing a sample handler 80 to reposition a sample plate 75 or to retrieve a second sample tray, in order to cause the ejector 90 to eject one or more second or subsequent droplets of the same selected sample, and at 524 one or more commands to a mass analyzer 100, 120, or a control component 127 thereof to analyze the samples.

It will be seen that in any or all of the above embodiments, a controller 135 can be operative to maintain timed records, so that ejected samples captured by capture probe 105 can be associated corresponding analysis results generated by the mass analysis instrument. For example, time/date stamp data can be generated and saved in a log in association with time of any or all of retrieval, ejection, capture, and analysis. The time recorded in the log can be introduced to the data processing system 400 for conduct data processing operations such as sample-data correlation as described herein.

Upon completion of the mass analysis and data generation associated with the mass analysis instrument 100, a signal indicative of the analysis completion may be transmitted at 526 from the mass analysis instrument 100 to the controller 135. The controller 135 upon receiving the signal indicative of analysis completion may transmit a triggering signal and at 528 to the data processing system 400. At 528, the raw mass spectrometry dataset generated by the mass analysis instrument 100 may also be transmitted along with the triggering signal to the data processing system 400. The data process system 400 upon receiving the triggering signal may activate an auto trigger module 402 thereof to initiate automatic data processing of the mass spectrometry dataset received from the mass analysis instrument according to the present disclosure. Any processed data and results of mass spectra analysis generated by the data processing system 400 may be saved at 530 in the data store 200 in a retrievable form.

As described above, the data processing system 400 may be operative to identify abnormal samples using the sample validation module 430. The data processing system 400 may send a feedback message or transmit a signal indicative of the abnormal samples at 530 or 532 to the controller 135 or any control components of other subsystems (e.g., ejector controller 92), through the use of the communication module 440. The controller 135 or control components of other subsystems upon receiving the feedback message may be further instructed to take responsive actions, e.g., conducting a new mass calibration, causing ejection of abnormal samples, or re-analyzing the abnormal samples, according to the present disclosure.

It will further be seen that the disclosure provides systems 10 and 10′ for analyzing collections of substance samples. Such a system can, for example, include one or more sample handlers 80 for retrieving a collection of samples from a sample source 70 and delivering the collection of samples to a capture location 110; a stage device 95 for receiving selected ones of the plurality of samples at the capture location 110 and locating or positioning a selected set of the samples in a capture position or capture location 110 proximate to a capture probe 105; one or more sample ejectors 90 for independently ejecting at least one of the selected set of samples into the capture location for capture by the capture probe 105. Such capture probe(s) can be configured to capture ejected sample(s) and dilute and transport them to mass analysis instrument(s) 100. Mass analysis instrument(s) 100 can be operative, for example through use of ion source(s) or generator(s) 115 produce sample ions and to filter and detect selected ions of interest from the sample ions. Computing system 103 can be operative, through use of computing device 200, controller 135, and data processing system 400 to conduct an automatic data processing process to analyze the acquired data generated from the mass analysis instrument 100. The controller 135 may be further operative to coordinate operation of the sample handler(s) 80, stage device(s) 95, sample ejector(s) 90, capture probe(s) 105, mass analysis instrument(s) 100, and the data processing system 400.

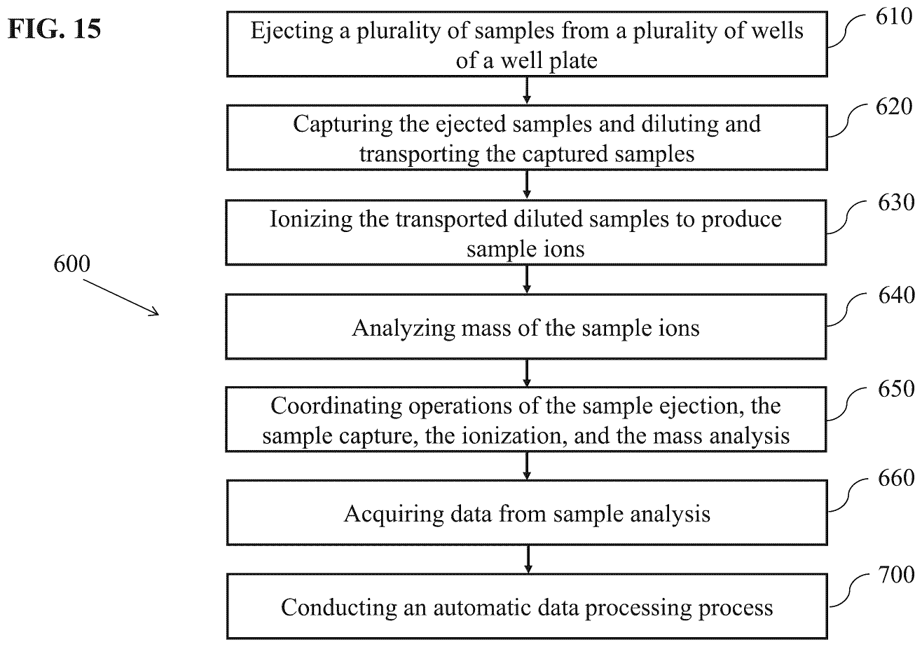

It will further be seen that the disclosure provides methods of using systems 10 or 10′ for analyzing pluralities of substance samples. FIG. 15 illustrates a flowchart of one particular example method in accordance with various embodiments of the present disclosure. In the illustrated example, the method 600 include operations 610, 620, 630, 640, 650, 660, and 700. At 610, a plurality of samples from a plurality of wells of a well plate are ejected by an ejector 90. At 620, the ejected samples and captured by a capture probe 105 and diluted and transported to a mass analysis instrument. At 630, the ejected samples transported to the mass analysis instrument 100 are ionized to produce sample ions (ionization products) for each ejected sample. At 640, the mass of the sample ions are analyzed by a mass analyzer 120. At 650, operations of the sample ejection, sample capture, ionization, and mass analysis are coordinated by a controller 135. At 660, the data generated from sample analysis are acquired by the controller 135. At 700, an automatic data processing process is conducted by a data processing system 400.

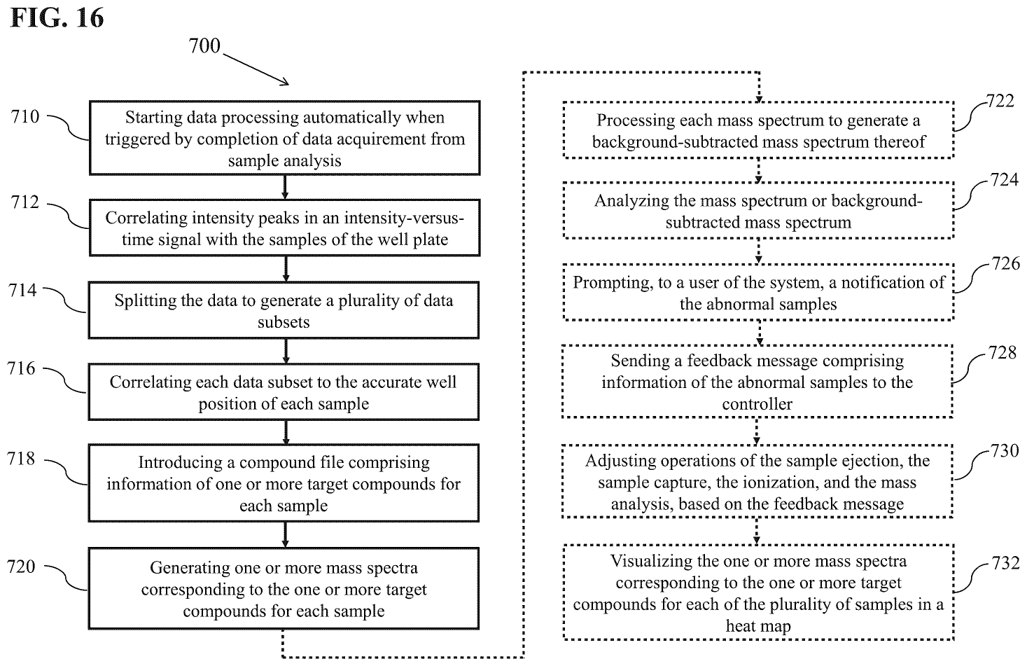

FIG. 16 illustrates a flowchart of one particular example of the operation 700 of FIG. 15, according to the present disclosure. In the illustrated example, the operation 700 further includes one or more or all of operations 710, 712, 714, 716, 718, 720, 722, 724, 726, 728, 730, and 732. At 710, a data processing process is automatically started through the use of an auto trigger module 402 when triggered by completion of data acquisition from the sample analysis at 660. At 720, intensity peaks in an intensity-versus-time signal are correlated with the samples or the corresponding well position of the well plate using a data processing module 410 or a data splitting module 412. At 714, the data is split by the data splitting module 412 to generate a plurality of data subsets, each data subset corresponding to a specific sample of the collection. At 716, each data subset is correlated to the accurate well position with respect to each sample of the collection through the use of a data correlation module 414. At 718, a compound file comprising information of one or more target compounds for each sample is introduced to the data processing system 400 through the use of a data introduction module 416. At 720, one or more mass spectra corresponding to the one or more target compounds for each sample are generated by a mass spectra generation module 420. At 722, the generated mass spectra are processed to generate a background-subtracted mass spectrum thereof, through the use of a mass spectra generation module 420 and a mass spectra analysis module 422. At 724, the mass spectrum or background-subtracted spectrum with respect to each sample is analyzed to identify the compounds or spectral features associated with the compound, through the use of a mass spectra analysis module 422, and/or a spectral comparison module 424, and/or a sample validation module 430. At 726, a notification indicative of an abnormal sample is prompted to a user by a communication module 440. At 728, a feedback message comprising information of the abnormal sample is sent to the controller 135, through the use of the communication module 440. At 730, operations of the sample ejection, the sample capture, the ionization, and the mass analysis are adjusted through the use of the controller 135. At 732, a heat map was generated for a user to visualize the one or more mass spectra corresponding to the one or more target compounds for each of the plurality of samples, through the use of a visualization module 460.

### Ionization Devices

Although the sample ionization process is described above in the context of AEMS using OPI and ESI, other techniques of generating ionized samples may be used according to various examples of this disclosure. For example, ionized samples may be generated by desorption electrospray ionization (DESI), which is a combination of ESI and desorption (DI) ionization methods. In DESI, ionization takes place by directing an electrically charged mist to the sample surface that is a few millimeters away. The electrospray mist is pneumatically directed at the sample where subsequent splashed droplets carry desorbed, ionized analytes. After ionization, the ions travel through air into the atmospheric pressure interface which is connected to the mass spectrometer.

Another ionization technique may include matrix-assisted laser desorption ionization (MALDI), which is an ionization technique that uses a laser energy absorbing matrix to create ions from large molecules with minimal fragmentation. In MALDI, a laser is fired at the matrix crystals in the dried-droplet spot. The matrix absorbs the laser energy; the matrix is desorbed and ionized (by addition of a proton) by this event. The hot plume produced during ablation contains many species: neutral and ionized matrix molecules, protonated and deprotonated matrix molecules, matrix clusters and nanodroplets.

Other ionization techniques may include rapid-fire mass spectrometry, liquid atmospheric pressure (LAP) MALDI, pneumatic ESI, (which generates ions for mass spectrometry using electrospray by applying a high voltage to a liquid to produce an aerosol), electron ionization (EI). EI may also be referred to as electron impact ionization or electron bombardment ionization, and is an ionization method in which energetic electrons interact with solid or gas phase atoms or molecules to produce ions. Any of the above techniques, as well as others that can perform sample ionization, may be used in examples of this disclosure.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some examples, some one or more of the most important method steps may be executed by such an apparatus.

Generally, embodiments of the present disclosure can be implemented through the use of computer program products with program codes, the program codes being operative for performing the operations described herein when the computer program product runs on a computer such as may be used to embody any or all of controllers 130, 82, 92, 96, 107, or 127, etc.

Although various embodiments and examples are described herein, those of ordinary skill in the art will understand that many modifications may be made thereto within the scope of the present disclosure. Accordingly, it is not intended that the scope of the disclosure in any way be limited by the examples provided.

1. A system for analyzing a collection of substance samples, the system comprising:
a sample ejector configured to eject, independently, a plurality of samples from a plurality of wells of a well plate, each of the plurality of samples corresponding to each of the plurality of wells;
a capture probe configured to capture the ejected samples and dilute and transport the captured samples;
a nebulizer nozzle configured to receive and ionize the transported diluted samples to produce sample ions;
a mass analysis instrument configured to filter and detect ions of interest from the sample ions;
a controller configured to coordinate operations of the sample ejector, the capture probe, the nebulizer nozzle, and the mass analysis instrument; and
a data processing system connected with the mass analysis instrument and the controller, wherein the data processing system is configured to acquire data from the mass analysis instrument and conduct an automatic data processing process.

2. The system of claim 1, wherein the automatic data processing process is triggered by completion of the acquiring the data from the mass analysis instrument.

3. The system of claim 1, wherein the automatic data processing process comprises:
correlating intensity peaks in an intensity-versus-time signal with the plurality of samples from the plurality of wells.

4. The system of claim 3, wherein the automatic data processing process further comprises:
splitting the data to generate a plurality of data subsets, each of the plurality of data subsets corresponding to each of the plurality of samples from the plurality of wells.

5. The system of claim 3, wherein the intensity peaks in the intensity-versus-time signal is correlated with the plurality of samples from the plurality of wells, based on acoustic ejection timing information of the sample ejector.

6. The system of claim 4, wherein the automatic data processing process further comprises:
introducing a compound file comprising information of one or more target compounds for each of the plurality of samples.

7. The system of claim 6, wherein the automatic data processing process further comprises:
generating one or more mass spectra corresponding to the one or more target compounds for each of the plurality of samples.

8. The system of claim 6, wherein the automatic data processing process further comprises:
generating a background spectrum; and
subtracting the background spectrum from the one or more mass spectra.

9. The system of claim 6, wherein the automatic data processing process further comprises:
identifying abnormal samples, among the plurality of samples, based on one or more validation rules.

10. The system of claim 9, wherein the one or more validation rules comprise a first validation rule, under which each of the abnormal samples has a mass shift larger than a threshold mass shift.

11. The system of claim 9, wherein the one or more validation rules comprise a second validation rule, under which each of the abnormal samples has an isotope pattern distribution similarity larger than a threshold isotope pattern distribution similarity.

12. The system of claim 9, wherein the automatic data processing process further comprises:
prompting, to a user of the system, a notification of the abnormal samples.

13. The system of claim 9, wherein the automatic data processing process further comprises:
sending a feedback message comprising information of the abnormal samples to the controller.

14. The system of claim 13, wherein the automatic data processing process further comprises:
adjusting the operations of the sample ejector, the capture probe, the nebulizer nozzle, and the mass analysis instrument, based on the feedback message.

15. The system of claim 13, wherein the automatic data processing process further comprises:
ejecting, independently, the abnormal samples, based on the feedback message.

16. The system of claim 7, wherein the automatic data processing process further comprises:
visualizing the one or more mass spectra corresponding to the one or more target compounds for each of the plurality of samples in a heat map.

17. The system of claim 7, wherein the automatic data processing process further comprises:
generating a report file comprising information of the one or more mass spectra corresponding to the one or more target compounds for each of the plurality of samples.

18. A method for analyzing collection of substance samples, comprising:
ejecting, by a sample ejector, a plurality of samples from a plurality of wells of a well plate, independently, each of the plurality of samples corresponding to each of the plurality of wells;
capturing, by a capture probe, the ejected samples and diluting and transporting the captured samples;
ionizing, by a nebulizer nozzle, the transported diluted samples to produce sample ions;
filtering and detecting, by a mass analysis instrument, ions of interest from the sample ions;
coordinating, by a controller, operations of the sample ejector, the capture probe, the nebulizer nozzle, and the mass analysis instrument; and
acquiring, by a data processing system connected with the mass analysis instrument and the controller, data from the mass analysis instrument and conducting an automatic data processing process.

19. A non-transitory computer-readable medium containing program instructions, wherein execution of the program instructions by one or more processors causes a system for analyzing collection of substance samples to:
eject, by a sample ejector, a plurality of samples from a plurality of wells of a well plate, independently, each of the plurality of samples corresponding to each of the plurality of wells;
capture, by a capture probe, the ejected samples and dilute and transport the captured samples;
ionize, by a nebulizer nozzle, the transported diluted samples to produce sample ions;
filter and detect, by a mass analysis instrument, ions of interest from the sample ions;
coordinate, by a controller, operations of the sample ejector, the capture probe, and the mass analysis instrument; and
acquire, by a data processing system connected with the mass analysis instrument and the controller, data from the mass analysis instrument and conduct an automatic data processing process.
